(19) United States
(12) Patent Application Publication
(10) Pub. No.: US 2010/0121669 A1
(43) Pub. Date: May 13, 2010

(54) System and method for determining how to prepare and maintain lawns and gardens

(76) Inventor: Daniel Paul Madigan, Green Bay, WI (US)

Correspondence Address: WEISS & WEISS, Suite 251, 300 Old Country Road, Mineola, NY, 11501, US

(21) Appl. No.: 12/291,849

(22) Filed: Nov. 13, 2008

(51) Int. Cl. G06Q 50/00; G06Q 99/00; G06Q 30/00

(52) U.S. Cl. 705/8; 705/400; 705/26; 705/1.1

(57) ABSTRACT

A system and method for determining how to prepare and maintain lawns and gardens.

### FIELD OF THE INVENTION

A system and method for determining how to prepare and maintain lawns and gardens.

### BACKGROUND OF THE INVENTION

There is a lot to know about gardening. Many books have been written on the subject. The internet has become a gigantic lawn and garden resource for material. Specifically, each plant already has information published. Month by Month information is already available on most plants. Specific information about soil is available. Information regarding growing zones is available. Further, soil fertility tests have been around for a long time.

The present invention provides the ability to customize a person's lawn and garden specific to the plants that a user needs, in the quantities that the user wants to place in their lawn or garden, and then get key growing information that simplifies what they need to buy, where they can buy it, and what they need to do all season long. How many gardeners have had garden failures because they did not prune right or at the right time? How many gardeners have had garden failures because they did not fertilize, fertilize at the right time, or fertilize with the right amounts? How many gardeners have had garden failures because they did not protect from insecticides or plant fungus?

Successful gardening is about doing a lot of things right and trying to avoid the one thing that can ruin the entire season. The present invention manages these issues for the user. Successful gardening is about knowing how to care for every plant in the best manner possible. There is a lot to learn on every plant. Combine that with multiple garden products, several fruit trees, and try keeping track of what you need to do when, gets to be a very difficult task. The present invention manages these issues for the user. Successful gardening is about knowing when to apply nutrients, what type and how much. How many people have found a per acre application rate and done the calculation to correlate this to their garden. Try this for every lawn and garden plant and people are bound to over fertilize or under fertilize. The present invention manages this for each user.

U.S. Pat. No. 7,167,834 relates to a garden and agricultural material identification method and apparatus. The method and apparatus identifies an appropriate gardening based on user responses to a plurality of inquiries. Inquiries may include location of the gardening need as well as type of pest. In a preferred embodiment, the method is practiced on an Internet site that provides the user with the opportunity to purchase identified gardening materials through the Internet. In a preferred embodiment, the gardening materials are identified based on geographic location of the user. The product label is also displayed based on state of user. The queries allow the gardener to specify the type of area in which a problem exists, the type of problem, and the geographic location of the problem. Once appropriate user response have been obtained, appropriate garden materials are identified to the user. The problems can relate to pests, fertilizer and seeds. After user responses have been input, the database is searched for an appropriate product based on the user responses. After a list of the appropriate products is presented, the user can see the label. The user is then queried whether they wish to purchase the product.

U.S. Pat. No. 7,069,232 relates to a system, method and computer program product for short-range weather adapted business forecasting. The system presents categories of products for which they would like to display short range weather adapted, business forecasting for example for lawn and garden.

US patent application publication no. 2006/0224327 relates to a system and method for plant selection. The processes may include providing a database of plant species and eliminating a portion of the plant species based on at least two search criteria including a user's desired climate zone or location plant cultivation, plant size, plant type, plant leaf type, plant form, plant primary attributes, parcel growing conditions, and desired characteristics.

U.S. Pat. No. 7,162,438 relates to a method for providing gardening/agricultural information and advice using an inventory of plant life on a user's property to generate a recommended plant maintenance plan. The method and system may be automated by a computer. The recommended maintenance plan includes recommended gardening materials and a schedule of times or time windows during which the materials should best be applied for all of the various plants. Also, specific instructions may be supplied to the user in a timely fashion as to when and how to apply various gardening materials, as well exactly which gardening materials should be applied, to the various types of plant life on the user's property. The recommended materials may be automatically sent to the user at the appropriate times and an account of the user may be automatically debited.

In one aspect of the invention a user generates an inventory of desired plants present on the user's property and identifies a geographical region. Based on the information supplied by the user, the user receives a recommended maintenance plan for the plant life on the user's property. The recommended maintenance plan includes: recommended gardening materials, recommended maintenance activities; and a recommended maintenance schedule of times or time windows during which the materials should best be applied and when the maintenance activities should be performed. Specific instructions are then supplied to the user in a timely fashion as to when and how to apply various gardening materials, as well as exactly which gardening materials should be applied to the various types of plant life on the user's property. Reminders may be provided to the users of when a gardening material should be provided. The recommended materials may be automatically sent to the user at the appropriate times and their card debited.

The computer compares an inventory of plant life on the user's property with stored maintenance data for each plant and generates a maintenance plan for the property. The system can also assist a user in identifying the plant life on their property, together with pests or other problems, based on user's response to series of questions.

In another aspect of the invention, a method and system for supplying automated gardening/agricultural information and advice is provided via the Internet, such that it may be accessed by a user. If the invention is performed on the Internet, the act of querying is performed by presenting a user with a number of choices that the user may be presented textually or graphically. The system makes sure what state the user is in. The system can contain a plant finder/solution finder process, a professional gardening advice process, a garden designer process, and a product purchasing process.

### SUMMARY OF THE INVENTION

The present invention relates to a system for determining how to prepare and maintain lawn and garden plants comprising: a software product wherein a user can input specific plants desired along with key growing and maintenance information. The system then provides to a user customized information to better manage the user's lawn and garden.

It is an object of the present invention for the lawn and garden plants to comprise lawn care plants and grasses, ornamental grasses, shrubs, trees, vines, fruits, herbs, vegetables and flowers. Flowers can be both annuals/perennials/bulbs/corms/rhizomes & tubers, or roses.

It is an object of the present invention for the key growing information to comprise actual space allocated for each plant. It is an object of the present invention for the actual space to be inputted in number of plants or in square feet.

It is an object of the present invention for key growing information to comprise information about the soil.

It is an object of the present invention for key growing information to comprise soil fertility information of the soil.

It is an object of the present invention for key growing information to comprise pH information of the soil. The pH of the soil helps the gardener to make specific adjustments to the soil specific to both the plants and the space allocated for the plants.

It is an object of the present invention for key growing information to comprise soil information. Soil can be classified into Sandy soil, Silty soil, Clay soil, Loamy Soil, Peaty Soil and Chalky Soil.

Soil fertility changes dramatically without proper care. It is an object of the present invention to provide a routine soil fertility test for a fertility evaluation. Soil samples are analyzed and computer recommendations are generated. A routine soil test package includes analyses for soil pH, phosphorus, potassium, calcium, magnesium, zinc, manganese, copper, iron and boron, along with fertilizer and lime recommendations. Soluble salts and organic matter information can also be inputted into the software.

It is an object of the present invention for the soil samples to be analyzed and computer recommendations generated.

Healthy, well-fed plants are better able to withstand diseases and insects and to compete with weeds.

It is an object of the present invention for key growing information to comprise plant problem information.

It is an object of this present invention for the plant problem information to comprise: insects, disease, wildlife, and weeds.

It is an object of the present invention that customized information comprises fertilizer application rates. The selection of the type of fertilizer and the quantity to be applied are time sensitive and specific to lawn and garden plants.

It is an object of the present invention that customized information comprises growing zone information.

It is an object of the present invention that customized information comprises pH amendment information. The pH adjustment products selected are time sensitive in their application and specific to the lawn and garden plants.

It is an object of the present invention that customized information comprises plant problem information. Plant problem information comprises pest management, moisture, weeds, fungus, nutrient management advice.

It is an object of the present invention that customized information comprises key seasonal issues.

It is an object of the present invention that customized information comprises watering application rates and methods.

It is an object of the present invention that customized information comprises pruning information.

It is an object of the present invention that customized information comprises mulching information. Since garden mulch could influence a composition as it decomposes, there is concern over how garden mulch selection impacts soil pH.

It is an object of the present invention that customized information comprises summary statement of products required for successful gardening. Products required include a summary list specific to your lawn and garden of plants to be purchased, amount of fertilizers required, pH amendment products, pesticides, insecticides, mulches in a single comprehensive shopping list specific to your lawn and garden needs.

It is an object of the present invention that customized information comprises an activity calendar. This calendar can be both a guide and a ledger for season lawn and garden activities.

It is an object of the present invention that customized information comprises location to buy products.

It is an object of the present invention that customized information comprises email alerts. It is an object of the present invention for the Email alerts to remind customers that it is time to prune, time to fertilize, time to check pH, time to cover plants for winter, time to weed, time to place an insecticide.

It is an object of the present invention that customized information comprises frequently asked questions.

It is an object of the present invention that customized information comprises expected crop yields.

It is an object of the present invention that customized information comprises simulated growing pictorials.

It is an object of the present invention that customized information comprises winter care guidelines.

It is an object of the present invention that customized information comprises planting guidelines.

It is an object of the present invention wherein a user inputs information about what products are present. The system plans a maintenance plan based on these products.

It is an object of the present invention for the products to include fertilizer, pesticides, herbicides, and gardening tools.

It is an object of the present invention for the key growing information to comprise information regarding frost zones.

It is an object of the present invention for the key growing information to include new plants, seeds, bare roots, bulbs, bushes, or trees needed to be purchased.

The present invention relates to a method for determining how to prepare lawn and garden products comprising: inputting specific plants desired along with key growing and maintenance information into a computer database. Customized information to the user from the database to better manage the user's lawn and garden based on the input from the user.

### DETAILED DESCRIPTION OF THE INVENTION

The present invention determines how to prepare and maintain lawn and garden plants through a software program where a user can input specific plants desired along with key growing and maintenance information. The system then provides to a user customized information to better manage the user's lawn and garden.

The lawn and garden plants comprise lawn care plants and grasses, ornamental grasses, shrubs, trees, vines, fruits, herbs, vegetables and flowers. Flowers can be both annuals/perennials/bulbs/corms/rhizomes & tubers, or roses.

In an embodiment, key growing information comprises actual space allocated for each plant. Actual space is inputted in number of plants or in square feet. For example, one could input a raspberry garden as 100 square feet into the software. On the other hand, one could input tomatoes as a quantity of plants. Either formula assists the software in customizing the specific needs of the plant.

In an embodiment, key growing information comprises information related to the soil. The pH of the soil helps the gardener make specific adjustments to the soil specific to both the plants and the space allocated for the plants. Key soil growing information can be information related to soil fertility. Key soil growing information can comprise soil type information. Soil can be classified into these following types:

Sandy soil

Silty soil

Clay soil

Loamy Soil

Peaty Soil

Chalky Soil

Sandy Soil—This type has the biggest particles and the size of the particles does determine the degree of aeration and drainage that the soil allows. It is granular and consists of rock and mineral particles that are very small. Therefore the texture is gritty and sandy soil is formed by the disintegration and weathering of rocks such as limestone, granite, quartz and shale. Sandy soil is easier to cultivate if it is rich in organic material but then it allows drainage more than is needed, thus resulting in over-drainage and dehydration of the plants in summer. It warms very fast in the spring season. So if a users wishes to grow their plant in sandy soil it is imperative that they water it regularly in the summers and give a break in the winters and rainy season, sandy soil retains moisture and nutrients. In a way sandy soil is good for plants since it lets the water go off so that it does not remain near the roots and lead them to decay.

Silty Soil—Silty soil is considered to be one of the most fertile of soils. It can occur in nature as soil or as suspended sediment in water column of a water body on the surface of the earth. It is composed of minerals like Quartz and fine organic particles. It is granular like sandy soil but it has more nutrients than sandy soil and it also offers better drainage. In the case silty soil is dry, it has a smoother texture and looks like dark sand. This type of soil can hold more moisture and at times becomes compact. It offers better drainage and is much easier to work with when it has moisture.

Clay Soil—Clay is a kind of material that occurs naturally and consists of very fine grained material with very less air spaces, that is the reason it is difficult to work with since the drainage in this soil is low, most of the time there is a chance of water logging and harm to the roots of the plant. Clay soil becomes very heavy when wet and if cultivation has to be done, organic fertilizers have to be added. Clay soil is formed after years of rock disintegration and weathering. It is also formed as sedimentary deposits after the rock is weathered, eroded and transported.

Loamy Soil—This soil consists of sand, silt and clay to some extent. It is considered to be the perfect soil. The texture is gritty and retains water very easily, yet the drainage is well. There are various kinds of loamy soil ranging from fertile to very muddy and thick sod. Yet out of all the different kinds of soil loamy soil is the ideal for cultivation.

Peaty Soil—This kind of soil is basically formed by the accumulation of dead and decayed organic matter, it naturally contains much more organic matter than most of the soils. It is generally found in marshy areas. The decomposition of the organic matter in Peaty soil is blocked by the acidity of the soil. This kind of soil is formed in wet climate. Though the soil is rich in organic matter, nutrients present are fewer in this soil type than any other type. Peaty soil is prone to water logging but if the soil is fertilized well and the drainage of the soil is looked after, it can be ideal for growing plants.

Chalky Soil—Unlike Peaty soil, Chalky soil is very alkaline in nature and consists of a large number of stones. The fertility of this kind of soil depends on the depth of the soil that is on the bed of chalk. This kind of soil is prone to dryness and in summers it is a poor choice for plantation, as the plants would need much more watering and fertilizing than on any other type of soil. Chalky Soil, apart from being dry also blocks the nutritional elements for the plants like Iron and Magnesium.

Every soil has its own advantages and disadvantages and there are various plants that have different requirements. Soil fertility changes dramatically without adding proper care. In an embodiment, a user performs a routine soil fertility test for a fertility evaluation. Soil samples are analyzed and computer recommendations are generated. A soil test package includes analyses for soil pH, phosphorus, potassium, calcium, magnesium, zinc, manganese, copper, iron and boron, along with fertilizer and lime recommendations. Soluble salts and organic matter information can also be inputted into the software.

Healthy, well-fed plants are better able to withstand diseases and insects and to compete with weeds.

In an embodiment, key growing information comprises information related to plant problem information. Plant problem information comprises insects, disease, wildlife, and weeds.

Insects, disease, wildlife, and weeds all add to the challenge of growing a healthy lawn and garden. Some are essential to our lawn and garden's success, while others are need to be managed to minimize their damage.

In an embodiment, customized information comprises fertilizer application rates. The selection of the type of fertilizer and the quantity to be applied are time sensitive and specific to lawn and garden plants.

In an embodiment, customized information comprises growing zone information.

In an embodiment, customized information comprises pH amendment information. The pH adjustment products selected are time sensitive in their application and specific to the lawn and garden plants.

In an embodiment, customized information comprises plant problem information. Plant problem information comprises pest management, moisture, weeds, fungus, nutrient management advice. A single failure in any of these areas can cause plant stress and failure.

In an embodiment, customized information comprises watering application rates and methods. Water is a key ingredient to plant life. However, too much water or too little water can cause plant stress.

In an embodiment, customized information comprises pruning information. For example, pruning everbearing raspberries is different than pruning summer bearing. To obtain maximum yield, one must learn proper pruning for each plant that requires pruning.

In an embodiment, customized information comprises mulching information. Since garden mulch could influence a composition as it decomposes, there is concern over how garden mulch selection impacts soil pH. Insulation value in summer is judged by the degree to which the garden mulch can keep the soil beneath cool and moist. A successful summer insulator will both reduce the need for watering and protect roots against extreme heat. The consideration of whether or not the garden mulch needs to be removed in spring is grounded in the fact that heavy organic garden mulches can smother emerging spring plants. This is obviously less of a factor, however, for plants that remain alive aboveground, throughout the winter. But even the latter can profit from having the soil around their roots warmed by the spring sun, a process facilitated by the temporary removal of the garden mulch.

In an embodiment customized information comprises summary statement of products required for successful gardening. Products required include a summary list specific to a user's lawn and garden of plants to be purchased, amount of fertilizers required, pH amendment products, pesticides, insecticides, mulches in a single comprehensive shopping list specific to a user's lawn and garden needs.

In an embodiment, customized information comprises an activity calendar. This calendar will is both a guide and a ledger for season lawn and garden activities.

In an embodiment, customized information comprises location to buy products. As new technology is developed, there are products available that perform better than traditional products. Latest technology products can be found and printed out specific to a person's lawn and garden and plant needs with locations to purchase.

In an embodiment, customized information comprises email alerts. In an embodiment, email alerts remind users that it is time to prune, time to fertilize, time to check pH, time to cover plants for winter, time to weed, time to place an insecticide.

In an embodiment, customized information comprises frequently asked questions.

In an embodiment, customized information comprises expected crop yields.

In an embodiment, customized information comprises simulated growing pictorials.

In an embodiment, customized information comprises winter care guidelines.

In an embodiment, customized information comprises planting guidelines.

In an embodiment, one of the factors for determining which plants are most suited for an area is the growing season. A growing season is defined by the total number of frost-free growing days. This is especially important to know when growing vegetables and annuals. Frost dates can also vary significantly depending on the topography of the area. If a person lives high on a hill, or deep in a valley, frost dates may be different then other gardeners in the same town.

In an embodiment, a user inputs information about what products are present. The system plans a maintenance plan based on these products. In an embodiment, the products include fertilizer, pesticides, herbicides, and gardening tools.

Understanding fertilizer application rates can be difficult. A 5-5-5 fertilizer requires twice the application rate as a 10-10-10 fertilizer. In an embodiment, these applications can be made easily. The user can enter either existing fertilizers or fertilizers locally available for purchase. In an embodiment, the invention provides a printout of fertilizer required to applied, which plants to be applied to, when to apply, and in the exact amounts customized to the available fertilizer grades available.

The present invention relates to a method for determining how to prepare lawn and garden products comprising: inputting specific plants desired along with key growing and maintenance information into a computer database. Customized information to the user from the database to better manage the user's lawn and garden based on the input from the user.

1. A system for determining how to prepare and maintain lawn and garden plants comprising:
a software product wherein a user inputs specific plants desired along with key growing and maintenance information;
said system providing to a user customized information to manage said user's lawn and garden.

2. The product of claim 1 wherein said lawn and garden plants comprises: lawn and grasses, ornamental grasses, shrubs, trees, vines, fruits, herbs, vegetables and flowers.

3. The product of claim 1 wherein said key growing information comprises actual space allocated for each plant.

4. The product of claim 3 wherein actual space is inputted in number of plants or square feet.

5. The product of claim 1 wherein said key growing information comprises information of the soil.

6. The product of claim 5 wherein said soil information comprises: soil fertility, pH and soil type.

7. The product of claim 1 wherein said key growing information comprises plant problem information.

8. The product of claim 7 wherein said plant problem information comprises: insects, disease, wildlife, and weeds.

9. The product of claim 1 wherein said system provides a user a soil fertility test package.

10. The product of claim 9 wherein said soil fertility test package comprises analyses for soil pH, phosphorous, potassium, calcium, magnesium, zinc, manganese, copper, iron, boron, along with fertilizer and lime tests.

11. The product of claim 10 wherein soil samples are analyzed and computer recommendations are generated.

12. The product of claim 1 wherein said customized information comprises fertilizer application rates.

13. The product of claim 1 wherein said customized information comprises growing zone information.

14. The product of claim 1 wherein said customized information comprises pH amendment information.

15. The product of claim 1 wherein said customized information comprises plant problem information.

16. The product of claim 15 wherein said plant problem information comprises pest management, moisture, weeds, fungus, nutrient management advice.

17. The product of claim 1 wherein said customized information comprises key seasonal issues.

18. The product of claim 1 wherein said customized information comprises watering application methods and rates.

19. The product of claim 1 wherein said customized information comprises pruning information.

20. The product of claim 1 wherein said customized information comprises mulching information.

21. The product of claim 1 wherein said customized information comprises summary statement of products required for gardening.

22. The product of claim 21 wherein said summary statement comprises: plants, seeds, bare roots, bulbs, bushes, or trees needed to be purchased, amount of fertilizer required, pH amendment products, pesticides, insecticides, and mulches.

23. The product of claim 1 wherein said customized information comprises an activity calendar.

24. The product of claim 1 wherein said customized information comprises location to buy products.

25. The product of claim 1 wherein said system further provides e-mail alerts.

26. The product of claim 1 wherein said customized information comprises frequently asked questions.

27. The product of claim 1 wherein said customized information comprises expected crop yields.

28. The product of claim 1 wherein said customized information comprises simulated growing pictorial.

29. The product of claim 1 wherein said customized information comprises winter care guidelines.

30. The product of claim 1 wherein said customized information comprises planting guidelines.

31. The product of claim 1 wherein a user inputs information about what products are available to a user, and said system plans a maintenance plan based on said products.

32. The product of claim 1 wherein said customized information includes information regarding fertilizer, pesticides, herbicides, and gardening tools.

33. The product of claim 1 wherein said key growing information comprises information regarding frost zones.

34. The product of claim 1 wherein said key growing information comprises information regarding frost dates.

35. The product of claim 1 wherein said key growing information includes new plants, seeds, bare roots, bulbs, bushes, or trees needed to be purchased.

36. A method for determining how to prepare lawn and garden plants comprising:
inputting specific plant desired along with key growing and maintenance information into a computer database;
providing customized information to said user from said database to better manage said user's lawn and garden based on said input from said user.
